(19) United States
(12) Patent Application Publication
(10) Pub. No.: US 2010/0242854 A1
(43) Pub. Date: Sep. 30, 2010

(54) ACCESS DEVICE FOR AN ANIMAL AND COMPUTER SYSTEM

(75) Inventors: Christoph Seger, Neumarkt (DE); Sebastian Soderer, Unterbuchfeld (DE); Florian Nuber, Berching (DE)

Correspondence Address: VENABLE LLP, P.O. BOX 34385, WASHINGTON, DC, 20043-9998, US

(73) Assignee: Feldberglicht GmbH, Kronberg (DE)

(21) Appl. No.: 12/718,696

(22) Filed: Mar. 5, 2010

(30) Foreign Application Priority Data
Mar. 5, 2009 (DE) 20 2009 002 677

(51) Int. Cl. A01K 1/035

(52) U.S. Cl. 119/484

(57) ABSTRACT

An access device for an animal that includes a housing, a door coupled to the housing, and a locking mechanism coupled to the housing to lock the door relative the housing. The device further includes a detection device to detect data of the animal depending on a body shape of the animal. The device also includes an evaluation unit coupled to the housing to evaluate the detected data and an activation device to activate the locking mechanism based on the evaluation of the detected data.

### CROSS-REFERENCE TO RELATED APPLICATION

This application claims the priority of German Patent Application No. 20 2009 002 677, filed on Mar. 5, 2009, the subject matter of which is incorporated herein by reference in its entirety.

### BACKGROUND

The subject matter of the application relates to an access device for an animal, in particular for a cat to access a cat flap.

Access devices for animals are known from the prior art which comprise a door, a door locking mechanism, a detection device for detecting the data of an animal using the access device, an evaluation unit for evaluating these data, and an activation device for activating the locking mechanism, based on the result of the evaluation. The term locking mechanism in this case is understood to refer to a mechanism that locks or releases the door.

Known, for example, are “intelligent” cat flaps where the cat wears a collar provided with an infrared transmitter, a key magnet or a RFID (radio frequency identification device) transponder. The signals received by a corresponding receiver installed in the flap are used to clear access through the flap for the cat wearing the collar.

To eliminate the danger of injury resulting from the wearing of collars, it is known to insert chips, which are already used in many cases for the purpose of registering animals, into cats as well for the purpose of identification. These chips are implanted below the skin in the neck area of the cat and are read by a read-out unit connected to the cat flap, thus also permitting a selective release of the flap.

### SUMMARY

It is an object of the present invention to provide an access device, as described in the above, which functions without elements attached to or implanted in the animal, for example collars or implanted chips

According to one aspect of the application, there is provided an access device for an animal, comprising: a housing; a door coupled to the housing; a locking mechanism coupled to the housing to lock the door relative the housing; a detection device coupled to the housing to detect data of the animal, the detected data depending on a body shape of the animal; an evaluation unit coupled to the housing to evaluate the detected data; and an activation device to activate the locking mechanism based on the evaluation of the detected data.

According to another aspect of the application, there is provided a method for operating an access door for an animal, comprising: detecting, by a detection device, the animal approximate the access door; receiving, by a receiver, data about the animal based on the detecting; storing, by a storage unit, the data about the animal; evaluating, by an evaluation unit, the stored data; activating a locking mechanism coupled with the access door in response to a signal produced by the evaluation unit.

According to another aspect of the invention, there is provided a computer system for operating an access door for an animal, the system comprising: a host processor; a datastore associated with the host processor, wherein the host processor is adapted to receive data about the animal near the access door, store the data about the animal on the datastore, evaluate the stored data, and transmit a signal to activate a locking mechanism coupled with the access door based on the evaluation.

The advantages and embodiments explained in the following in connection with a method apply in the same way to the device according to the invention and vice versa.

The access device according to an embodiment of the invention is distinguished in that the detected data which may be evaluated for activating the locking mechanism are data depending on the animal body shape.

In other words, one core idea behind an embodiment of the invention is that the decision for activating the locking mechanism and thus the decision for opening (or closing or keeping closed) the door is based on the data depending on the animal body shape.

Since each animal has an individual body shape and, in particular, animals of different species have differently shaped bodies, it can be determined with the aid of an embodiment of the invention whether or not the animal is an animal that is allowed to pass through the door. For example, access can be granted to one's own cat or dog while a strange cat or strange dog or a wild animal such as a marten, a fox or a rat can be denied access.

According to embodiments of the invention, a particularly secure access control is created, and a selective opening of the door may be prevented if the animal carries an object in its mouth, for example a cat carrying a mouse or other object and trying to pass through the door. Given this background, the term “depending on the body shape” is understood to mean that it describes not only the actual shape of the animal approaching the door, but alternatively also the total shape and profile of the animal, meaning the animal body and the object carried by the animal. As a result of the inventive concept of using data depending on the body shape, it is thus possible to prevent the animal from bringing in live, semi-dead or dead prey as well as to effectively prevent an undesirable dirtying of the apartment or house. This is not possible with the above-described standard cat flaps and represents an advantage as compared to known animal access devices.

According to one embodiment of the invention, the detected data depend on the outline or profile of at least a portion of the animal body. When used with access devices, the outline is particularly suitable for characterizing the body shape because this body shape is comparably easy to detect and because the outline is especially reliable for detecting the body shape.

According to another embodiment of the invention, the detected data are data dependent only on the outline of a portion of the animal body. This detection of a partial contour of the animal body noticeably simplifies the method and technical expenditure, without affecting the accuracy and reliability of the results. The reason, among other things, is that even a comparably short outline permits an identification of the animal and thus the access control.

Data depending on the body shape and especially outlines can be detected particularly easily with the aid of an optical detection device. According to one embodiment of the invention, the detection device comprises a number of optical transmitters and receivers, preferably arranged in pairs, which are advantageously arranged near the door, such that the data are detected in an essentially vertically extending detection region. The wavelength used for detecting the outline can vary, wherein the use of infrared light has proven to be especially suitable and also reliable.

According to another embodiment of the invention, the device for evaluating the data comprises a computing unit, and more specifically, a micro-controller. Insofar as data needed to be stored, for example the detected data, evaluation results, tolerance values or the like, the evaluation unit is provided with a storage element such as a memory chip that is connected to the microcontroller. An extremely fast and simultaneously comparably cheap evaluation of the data is possible when using an electronic computing unit. At the same time, the evaluation algorithms as well as all connected parameters, threshold values and the like can be changed quite easily and flexibly. Different types of access devices can be provided with a single type of evaluation unit, wherein only the programming of the computing unit must be adapted to the respective application case. The access device can be adapted to different animals, in particular small animals such as cats, small dogs and the like through a corresponding adaptation of the evaluation unit and can therefore be used with extreme flexibility.

One embodiment of the invention provides that the detected data is exclusively used for the evaluation, along with one or several parameters that can be adjusted by the manufacturer or the buyer. A comparison of the detected data to an available reference image, a template or the like in particular is not required. The detection consequently is very fast and not very susceptible to errors. The installation and operation are also very simple since the buyer only needs to make a few adjustments, if any at all, for example the adjustment of the tolerance value. Thus, it is also not necessary for operating the access device to take a photograph of the animal to serve as a template.

According to yet another embodiment of the invention, the computing unit is designed such that the data evaluation involves a comparison of at least a first part of the detected data with at least a second part of the detected data and that at least two control values are determined based on the results of the data comparison. The differences of the control values are then compared to an adjustable tolerance value, wherein the locking mechanism is actuated by using the result of this tolerance-value comparison. A secure detection of the animal may be possible with low computing expenditure.

In one embodiment of the invention, the computing unit is designed such that the evaluation of the detected data only involves the use of the data itself. Evaluation algorithms, in particular, are used which process exclusively the actually detected data depending on the body shape without requiring the buyer or manufacturer to make available tolerance values or the like. In other words, a self-learning access device is provided, for which the necessary tolerance values are determined by the evaluation unit from the detected data. A teaching operation is therefore required prior to the actual operation of the access device. For this, the evaluation unit “learns” the animal-specific body-shape dependent data while the animal runs through the door and then automatically determines all values necessary for a secure detection operation.

The computing and data processing unit is designed to carry out all steps necessary for the above-described method in connection with the processing of data. The computing unit preferably comprises a number of functional modules, wherein each functional module is embodied to realize a specific function or a number of specific functions according to the described method. The functional modules can be hardware modules or software modules. In other words, insofar as the computing unit is concerned, an embodiment of the invention may be either in the form of computer hardware or computer software or with a combination of hardware and software.

Insofar as the invention is embodied as software, meaning as a computer program product or computer readable program code, all described functions are realized with computer program instructions to be read by a computer with processor. The computer program instructions are realized, in a manner known per se, with an optional programming language and can be made available to the computer in optional form, e.g. in the form of data bundles transmitted via a computer network, or as a computer program product stored on a disc, a CD ROM or other data carrier.

The computing unit may be a microcontroller so that the corresponding functionality of an embodiment of the invention may be realized in the form of hardware. If a software implementation exists, the computer program may also comprise computer program instructions for evaluating the data detected by the detection device, wherein the detected data are data depending on the animal body shape.

According to a different embodiment of the invention, the computer program comprises instructions for evaluating these data, provided the computer program is run on a computer, wherein the data evaluation is realized using exclusively the data themselves.

According to yet another embodiment of the invention, the computer program comprises instructions for evaluating these data, provided the program is run on a computer, wherein the evaluation involves a data comparison of at least a first part of the detected data with at least a second part of the detected data and at least two control values are determined based on the result of the this data comparison. The difference between these two values is then compared to a tolerance value that can be adjusted, wherein the locking mechanism is actuated based on the result of the tolerance comparison.

In summary, embodiments of the invention provide an easy to produce, cheap, space-saving, simple to install, reliable, functional and easy to operate electronically controlled access device with low energy consumption which does not harm animals and functions without elements installed on or in the animal, such as collars or implanted chips.

An embodiment of the invention advantageously relates to a cat flap which detects with the aid of light barriers a portion of the outline of a cat head moving through the light barriers and, simply by counting the interrupted light beams, issues a corresponding signal for opening or closing the cat flap.

The access device according to an embodiment of the invention thus functions without requiring the use of expensive and complex technology. The access control is made possible with a simple device, thus keeping the costs for producing the access device comparably low.

To achieve an even higher operational safety, the technology of a further embodiment of the invention can also be combined with detection techniques known from the prior art. For example, it is possible to embody the access device in such a way that access is not granted solely on the basis of animal-dependent shape data, but that an additional detection of the animal is required for opening the door, for example using an infrared sensor, key magnet or RFID transponder arranged in the collar or a chip implanted in the animal.

According to other embodiments of the invention, a decision on activating the locking mechanism and thus a decision on whether to open the door is not made solely on the basis of animal-dependent shape data. Further, the detection of the animal according to another embodiment of the invention could also be used to trigger a specific different operation in addition to or alternative to activating the locking mechanism, for example sending out an optical or acoustic signal or notifying the animal owner.

### BRIEF DESCRIPTION OF THE DRAWINGS

The subject matter of the application will be more readily understood from the following detailed description when read in conjunction with the accompanying drawings, in which:

FIG. 1 is a schematic representation of an access device;

FIG. 2 is a perspective representation of an access device, as seen from the front;

FIG. 3 is a perspective representation of an access device as seen from the back;

FIG. 4 is a schematic representation of an access device as seen from the front;

FIG. 5 is a diagram illustrating an example using a cat;

FIG. 6 is a diagram illustrating an example using a cat with a mouse; and

FIG. 7 is a diagram illustrating an example using a different animal.

### DETAILED DESCRIPTION

The Figures show embodiments of the invention only schematically and only its essential components. The same reference numbers are used for the same elements with the same or comparable function.

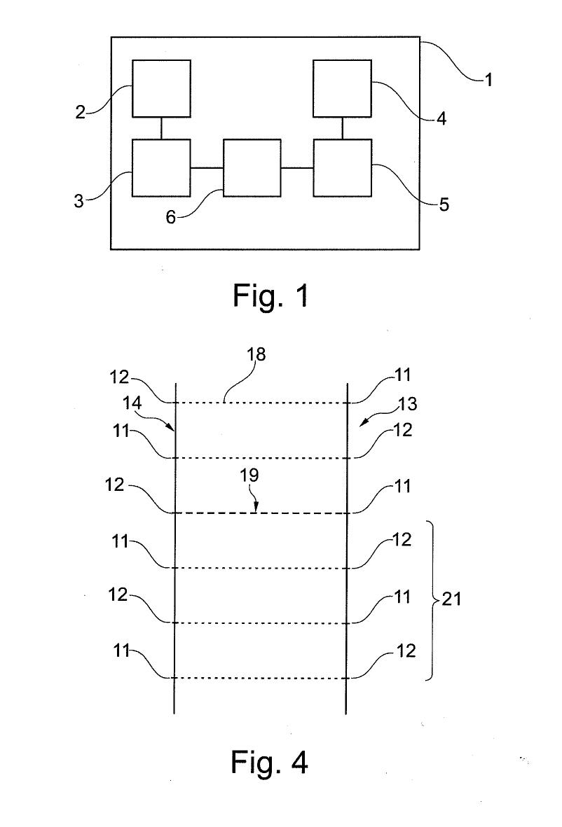

As shown schematically in FIG. 1, the cat flap according to an embodiment of the invention comprises a door 2, a locking mechanism 3 for the door 2, a detection device 4 for detecting data depending on the shape of an animal approaching the door 2 and thus the cat flap 1, an evaluation unit 5 for evaluating these data and an activation device 6 for activating the locking mechanism 3, using the results of the evaluation.

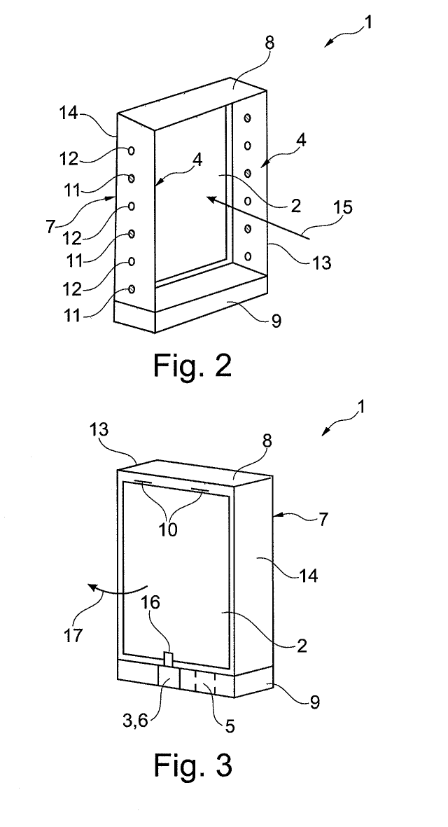

With the aid of FIGS. 2 and 3, the structural design of the cat flap 1 is described in the following. The cat flap 1 is embodied as a closed system. The basic structure of the cat flap 1 involves a frame structure or housing 7 with an upper crossbar 8 and a lower crossbar embodied as a base 9. The door 2 is embodied as a flap attached with hinges 10 on the top, so as to permit the flap to swivel in the frame 7. The detection device 4 consists of a number of optical transmitters 11 and receivers 12, arranged in pairs such that they form strips in the two vertical side part 13, 14 of the frame 7. The light barriers thus form a vertical detection region spanned by these light barriers if the frame 7 as shown is installed in an apartment door or a house door or even in a wall. FIG. 2 shows the left side part 14 transparent in order to illustrate the arrangement of the transmitters 11 and receivers 12 in this side part.

The transmitters 11 may be infrared light-emitting diodes (IR-LEDs), for example, while NPN silicon phototransistors are used for the receivers 12. The elements 11, 12 may have a good length of service life and optimal current consumption and radiation intensity. However, other suitable transmitters and receivers can also be used.

Respectively six transmitters 11 and receivers 12 are shown symbolically in the Figures. The strips on the whole may comprise 24 transmitters 11 and 24 receivers 12, so as to form 24 light barriers. The number of light barriers determines the resolution and thus the accuracy of the detection and can vary, depending on the application case and the size of the access device.

Given a structural height of approximately 3 mm, the transmitters 11 and the receivers 12 are small enough so that a sufficiently high number of light barriers can be accommodated in the available installation space to meet the resolution required for the desired animal detection.

To ensure that there is no overlapping of the light cones of the IR-LEDs and that no errors occur during the data detection, the transmitters 11 and the receivers 12 are arranged alternating in the side parts 13, 14. In addition, the light cone for the IR LEDs can be restricted with structural measures.

With the aid of the transmitter/receiver strips, it is possible to detect the outline of an animal entering the detection region in incoming direction 15. The data detected in the process are supplied by the detection device 4 to an evaluation unit 5 in the form of a microcontroller for which the operation is explained in further detail below. The space required for operating the microcontroller 5, including the controller board and the necessary circuit with signal amplifiers and the like, is familiar to one skilled in the art, so that it need not be discussed further herein.

Following the evaluation of the data, the microcontroller 5 triggers the activation device 6 for the locking mechanism 3. The locking mechanism 3 comprises a simple catch 16, which prevents an opening of the flap 2 in incoming direction 15. On the other hand, the flap 2 can always be opened in the opposite, outgoing direction. The catch 16 is embodied, for example, as a metal component that is positioned so as to be spring-operated. The activation device 6, which is housed in the base 9 of the frame 7, comprises a magnetic switch that can be triggered with the aid of the microcontroller 5. An electromagnet in the switch cooperates with the catch 16 to move the switch counter to the spring force from a locked position downward to an opened position in which the flap 2 can be mechanically activated to swing inward in the direction 17. To return to the locked position, the electromagnet is simply deactivated and a spring that simultaneously functions as support for the catch pushes the catch 16 upward and back into the locked position.

The frame 7, which simultaneously functions as a housing, contains all elements required for the operation of the cat flap 1, in particular the detection devices 4, 11, 12, the evaluation unit 5 and the activation device 6. It is not important whether the evaluation unit 5 is installed in the base housing or in the upper cross bar 8 and can therefore be made to depend on the desired design of the cat flap 1.

The frame 7 is furthermore sealed weatherproof and thus protects all integrated elements against wind, rain and the like. The edges of the housing parts are sealed with sealing elements, for example filler material and O-rings. The encapsulated, integrated design not only permits a particularly easy installation, but also makes more difficult any manipulation from the outside or theft of individual components. The microcontroller 5 and the activation device 6 are supplied with the required operating voltage via a battery that is also integrated into the frame 7 or via rechargeable accumulators. Connecting cables or the like are therefore not required. According to a different embodiment, a connection to an electric grid via a standard house electrical outlet can also be provided as an alternative to or in addition to the battery operation.

The detection and evaluation of the data is described in further detail in the following with reference to the FIGS. 4 to 7.

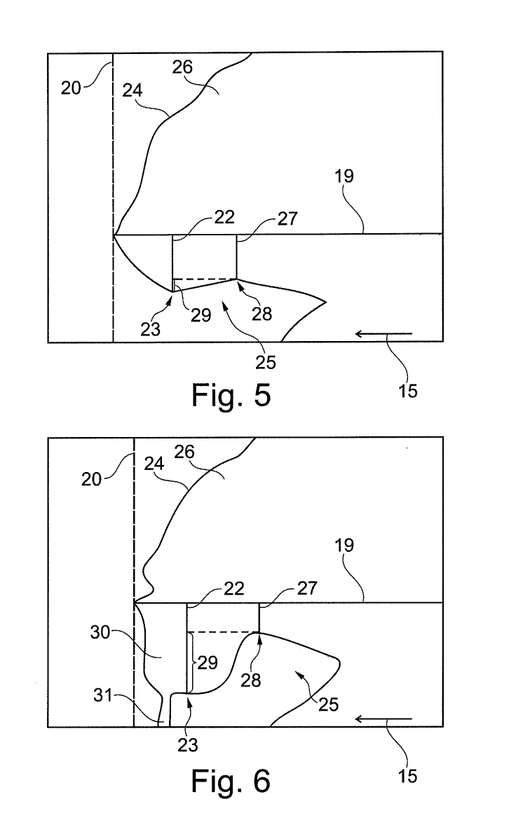

The status of the light barrier is queried by the microcontroller 5 at regular intervals, for example ten times per second. The query starts with the upper light barrier 18, meaning the one closest to the upper cross bar 8, and is continued in downward direction. Once an animal enters the detection region, it is recorded which light barrier is first interrupted, wherein this forms an upper limit 19 for all other queries, as shown in FIG. 4. In FIGS. 5 to 7, this upper limit 19 is imaged symbolically as starting point 20. It means that subsequently only those light barriers are queried, which are located in a region 21 below the initially activated light barrier, meaning the upper limit 19. This is synonymous with the fact that the detected data depend on the outline of only a portion of the animal body, namely the underside of the animal head; see FIGS. 5 to 7. Potential sources for inaccuracies during the detection can thus be omitted, such as the position of the ears.

Once it is determined how many light barriers are still located below the initially activated light barrier 19, it is determined with the aid of the additional queries at regular intervals how many of these light barriers are interrupted at the moment. A series of query results are thus obtained. Immediately after each query, it is determined whether the last determined number of interrupted light barriers is higher or lower than the previously detected number of interrupted light barriers. In other words, a comparison is made between a first part of the detected data and a second part of the detected data. A maximum value 22 is determined in this way, which corresponds to an especially high number of interrupted light barriers and to a lower edge 23 of the outline 24 for the underside of the head 25 belonging to the animal 26. This maximum value 22 is stored as the first control value in the microcontroller 5.

Subsequently, a minimum value 27 is determined using the same principle and based on the series of query results from the continuous queries, wherein this value corresponds to a particularly low number of interrupted light barriers and an upper edge 28 of the outline 24 for the underside of the head 25 of the animal 26. This minimum value 27 is stored as the second control value in the microcontroller 5. The minimum value 27 and the maximum value 22 are shown symbolically as the distance between the limit defined by the first activated light barrier 19 and the lower or upper edges 23, 28 of the outline 24.

The maximum value 22 and the minimum value 27 can also be determined in a manner other than with a simple comparison of adjacent values, for example by using known mathematical methods for determining extreme values. If the outline 24 has no minimum or maximum values, the “course of the curve” for the outline 24 can be evaluated, for example by determining reversing points or the like, thus permitting a positive or negative detection.

The query of the light barriers is stopped when both control values 22, 27 have been detected. Alternatively, an additional light barrier can be provided (not shown herein), which is arranged in incoming direction 15 between the detection region and the door 2, wherein the interruption of this light barrier stops the query of the light barriers arranged in the side parts 13, 14.

The microcontroller 5 subsequently determines the distance between the two control values 22, 27. The determined control value difference 29 is compared to a tolerance value that can be preset by the manufacturer or can be adjusted by the buyer. If the control value difference 29 is lower than the tolerance value, as is the case with the situation exemplified in FIG. 5, the microcontroller 5 triggers the locking mechanism 3 for releasing the lock so that the flap 2 can open up. If the control value difference 29 is higher than the tolerance value, then the lock remains in the locked position and the flap 2 cannot be opened from the outside, e.g. if the animal 26 carries an object in its mouth as shown with the example of a mouse in FIG. 6. For the example described herein, it is assumed that the mouse tail 31 is not detected and thus does not influence the control value 22. In practical operations, the tail can be detected in some circumstances, wherein this will result in an even higher control value difference.

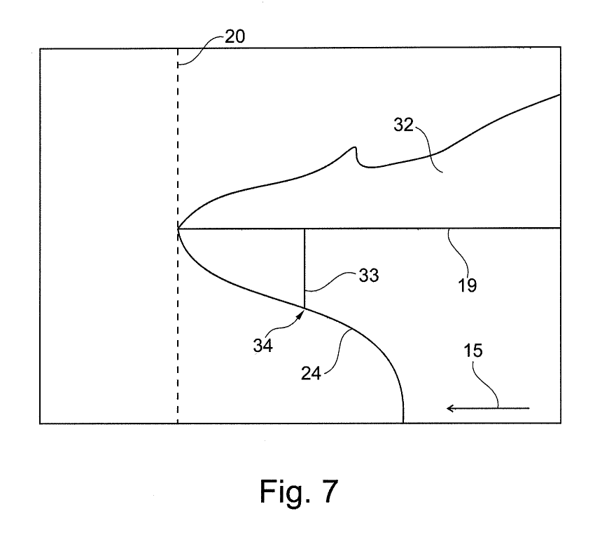

Independent of the detection of an object 30 carried by the animal 26, a decision on whether or not to open up the flap 2 can already be made by determining the control values 22, 27. The underside of the head 25 of a cat, for example, has a different outline 24 than a rat 32 or the like (FIG. 5) for which a single control value 33 is determined with the aid of the point 34 where the upward slope of the outline 24 (FIG. 7) is reversed.

According to one embodiment, the tolerance value can be determined solely with the microcontroller 5 in that the characteristic outline 24 of the respective animal 26 is detected prior to the actual operation during a learning mode and these data are subsequently used to determine a tolerance value. It is advantageous in that case to repeat the learning process several times. The programming of the microcontroller 5 for this embodiment is suitable for determining the tolerance value.

Independent of the above-described embodiment, additional designs for the cat flap 1 can be provided while maintaining the basic idea behind embodiments of the invention. For example, it is possible to vary the distance between the light barriers 11, 12 and the flap 2. To lower current consumption, it is furthermore possible to provide an activation light barrier (not shown herein), which is located in front of the detection region, as seen in incoming direction 15. In that case, the data detection is activated only if the animal 26 breaks through the activation light barrier.

It is also possible to use in place of an activation light barrier a contactless, inductive approximation switch, a contactless approximation switch based on ultrasound or radar, a rocker switch that can be activated by the animal or a different mechanism known from the prior art, so that the current for operating the cat flap is activated only if necessary.

A tolerance value range is specified according to one modified embodiment, meaning a comparison is made between the control value difference 29 and an upper as well as a lower tolerance value. As a result, the access device can be adapted even better to the detection requirements.

It is furthermore possible not to carry out a predetermined control value determination for which initially a maximum value and then a minimum value are determined, but instead to detect the course of the outline 24 open-ended and then evaluate it. The application range for the access device can thus be increased even further. For example, animals can be detected by their outlines and can be securely prevented from entering.

All features listed in the description, the following claims and shown in the drawing can be essential to an embodiment of the invention either by themselves or in any combination.

It will be understood that the above description of the present invention is susceptible to various modifications, changes and adaptations, and the same are intended to be comprehended within the meaning and range of equivalents of the appended claims.

What is claimed is:

1. An access device for an animal, comprising:
a housing;
a door coupled to the housing;
a locking mechanism coupled to the housing to lock the door relative the housing;
a detection device coupled to the housing to detect data of the animal, the detected data depending on a body shape of the animal;
an evaluation unit coupled to the housing to evaluate the detected data; and
an activation device to activate the locking mechanism based on the evaluation of the detected data.

2. The access device according to claim 1, wherein the detected data depends on the outline of at least a portion of the animal body.

3. The access device according to claim 1, wherein the detected data depends on the outline of only a portion of the animal body.

4. The access device according to claim 1, wherein the detection device comprises a plurality of optical transmitters and receivers arranged near the door, wherein the data is detected in an approximately vertically extending detection region.

5. The access device according to claim 1, wherein the evaluation unit comprises a computing unit to evaluate the detected data.

6. The access device according to claim 5, wherein the computing unit compares a first part of the detected data with at least a second part of the detected data to determine first and second control values based on a result of the comparison, wherein the computing unit compares a difference between the first and second control values with an adjustable tolerance value and the locking mechanism is activated as a function of the tolerance value comparison.

7. The access device according to claim 5, wherein the computing unit solely evaluates the detected data.

8. A computer readable program code for operating an access device for an animal, the device including a housing; a door coupled to the housing; a locking mechanism coupled to the housing to lock the door relative the housing; a detection device coupled to the housing to detect data of the animal, the detected data depending on a body shape of the animal; an evaluation unit, comprising a computing unit, coupled to the housing to evaluate the detected data; and an activation device to activate the locking mechanism based on the evaluation of the detected data, wherein the computer readable program code comprises instructions to evaluate the data detected by the detection device.

9. The computer readable program code according to claim 8, further comprising instructions to cause the evaluation unit to evaluate solely the detected data.

10. The computer readable program code according to claim 9, wherein the instructions cause the evaluation unit to compare at least a first part of the detected data with at least a second part of the detected data, to determine at least two control values based on the results of the data comparison, to take the difference of the control values and to compare the difference to an adjustable tolerance value, and to activate the locking mechanism based on the tolerance value comparison.

11. The access device according to claim 4, wherein the respective transmitter is arranged with the respective receiver in a pair.

12. The access device according to claim 5, wherein the computing unit comprises a microcontroller

13. A method for operating an access door for an animal, comprising:
detecting, by a detection device, the animal approximate the access door;
receiving, by a receiver, data about the animal based on the detecting;
storing, by a storage unit, the data about the animal;
evaluating, by an evaluation unit, the stored data;
activating a locking mechanism coupled with the access door in response to a signal produced by the evaluation unit.

14. The method according to claim 13, wherein the evaluating further comprises
comparing a first part of the data with at least a second part of the data;
determining a first control value and a second control value based on the comparison;
calculating a difference between the first control value and the second control value; and
comparing the difference with an adjustable tolerance value to product the signal.

15. A computer system for operating an access door for an animal, the system comprising:
a host processor;
a datastore associated with the host processor, wherein the host processor is adapted to
receive data about the animal near the access door;
store the data about the animal on the datastore;
evaluate the stored data; and
transmit a signal to activate a locking mechanism coupled with the access door on the evaluation.

16. The computer system according to claim 15, wherein the host processor is further adapted to compare a first part of the data with at least a second part of the data;
determine a first control value and a second control value based on the comparison;
calculate a difference between the first control value and the second control value; and
compare the difference with an adjustable tolerance value to produce the signal.
